(19) United States
(12) Patent Application Publication
(10) Pub. No.: US 2023/0125168 A1
(43) Pub. Date: Apr. 27, 2023

(54) METHOD AND APPARATUS FOR MAINTAINING PRIORITY OF VPLMN DUE TO MULTIPLE SoR SECURITY CHECK FAILURES

(71) Applicant: Samsung Electronics Co., Ltd., Suwon-si (KR)

(72) Inventors: Lalith KUMAR, Bangalore (IN); Arijit SEN, Bangalore (IN); Danish Ehsan HASHMI, Bangalore (IN); Koustav ROY, Bangalore (IN)

(21) Appl. No.: 18/050,380

(22) Filed: Oct. 27, 2022

(30) Foreign Application Priority Data
Oct. 27, 2021 (IN) 202141049194
Nov. 10, 2021 (IN) 202141051596
Jan. 3, 2022 (IN) 202241000272
Oct. 24, 2022 (IN) 202141049194

(51) Int. Cl. H04W 76/10; H04W 60/04; H04W 76/20; H04W 48/18

(52) U.S. Cl. CPC H04W 76/10; H04W 60/04; H04W 76/20; H04W 48/18; H04W 84/042

(57) ABSTRACT

The disclosure relates to a fifth generation (5G) or sixth generation (6G) communication system. Embodiments herein disclose methods for maintaining priority of a VPLMN during a PLMN selection procedure by a UE. The method includes ignoring a pre-configured priority for a VPLMN and considering the VPLMN as a lowest priority in response to determining that the UE has entered a state and the second SOR information is not received before the UE enters the state or the received second SOR information security check is not successful. The method includes considering a priority of the VPLMN as the pre-configured priority by not considering the VPLMN as a lowest priority and stopping the timer associated with the “first SOR security check not successful” in response to determining that the UE receives the second SOR information and a second SOR security check is successful before the UE enters the state.

### CROSS REFERENCE TO RELATED APPLICATIONS

This application is based on and claims priority under 35 U.S.C. § 119 to Indian Provisional Application No. 202141049194, filed on Oct. 27, 2021, Indian Provisional Application No. 202141051596 filed on Nov. 10, 2021, Indian Provisional Application No. 202241000272 filed on Jan. 3, 2022, and Indian Complete Specification Application No. 202141049194 filed on Oct. 24, 2022, the contents of which are incorporated herein by reference

### BACKGROUND

### 1. Field

Embodiments disclosed herein relate to wireless communication networks, and more particularly to methods and a User Equipment (UE) for maintaining priority of visited public land mobile networks (VPLMNs) in the wireless communication networks, due to multiple Steering of Roaming (SoR) security check failures.

### 2. Description of Related Art

Fifth generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, New Radio (NR) User Equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Accordingly, the embodiments herein provide methods for maintaining priority of a visited public land mobile network (VPLMN) during a public land mobile network (PLMN) selection procedure. The method includes determining, by a UE, that a first Steering of Roaming (SOR) security check failure occurs upon receiving a first SOR information at the UE. The UE is configured with a pre-configured priority for the VPLMN. Further, the method includes starting, by the UE, a timer with a value included in a steering of roaming connected mode control information (SOR-CMCI) in response to determination. Further, the method includes determining, by the UE, whether the UE has entered a connectivity state and a second SOR information is received before the UE entering into the state. In an embodiment, the method includes ignoring the pre-configured priority for the VPLMN and considering the VPLMN as a lowest priority in response to determining that the UE has entered into the connectivity state and the second SOR information is not received before the UE entering into the state or the received second SOR information security check is not successful. In another embodiment, the method includes considering a priority of the VPLMN as the pre-configured priority by not considering the VPLMN as a lowest priority and stopping the timer associated with the “first SOR security check not successful” in response to determining that the UE receives the second SOR information and a second SOR security check is successful before the UE enters into the connectivity state.

In an embodiment, the timer with the value is associated with the “SOR security check not successful” is included in the SOR-CMCI stored at the UE. The timer comprises a Tsor-cm timer.

In an embodiment, at least one of the first SOR information and the second SOR information are provided in a downlink Non-access stratum (DL NAS) transport message or registration accept message or any other NAS message to the UE.

In an embodiment, the connectivity state is at least one of IDLE state and the fifth generation mobility management (5GMM)-CONNECTED mode with a radio resource control (RRC) inactive indication state.

Accordingly, the embodiments herein provide a UE including a PLMN selection procedure controller coupled with a processor and a memory. The PLMN selection procedure controller is configured to determine that a first SOR security check failure occurs upon receiving a first SOR information at the UE. The UE is configured with a pre-configured priority for the VPLMN. Further, the PLMN selection procedure controller is configured to start a timer with a value included in a SOR-CMCI in response determination. Further, the PLMN selection procedure controller is configured to determine whether the UE has entered a connectivity state and a second SOR information is received before the UE entering into the state. In an embodiment, the PLMN selection procedure controller is configured to ignore the pre-configured priority for the VPLMN and consider the VPLMN as a lowest priority in response to determine that the UE has entered into the connectivity state and the second SOR information is not received before the UE entering into the state or the received second SOR information security check is not successful. In another embodiment, the PLMN selection procedure controller is configured to consider a priority of the VPLMN as the pre-configured priority by not considering the VPLMN as a lowest priority and stop the timer associated with the “first SOR security check not successful” in response to determining that the UE receives the second SOR information and a second SOR security check is successful before the UE enters into the connectivity state.

Accordingly, the embodiments herein provide methods for maintaining priority of a VPLMN during a PLMN selection procedure. The method includes receiving, by a UE, a message indicating one of a re-registration required field and a registration required field. Further, the method includes completing, by the UE, one of a de-registration procedure and a generic UE configuration update procedure based on the message. Further, the method includes determining, by the UE, whether at least one timer is running after the completion of one of the de-registration procedure, the generic UE configuration update procedure, and a release of an existing Non-access stratum (NAS) signalling connection. In an embodiment, the method includes stopping the at least one timer and attempt to obtain at least one service on a higher priority PLMN on a 3rd Generation Partnership Project (3GPP) access in response to determining that at least one timer is running after the completion of one of the de-registration procedure and the generic UE configuration update procedure. In another embodiment, the method includes initiating an initial registration in response to determining that at least one timer is not running after the completion of the de-registration procedure. In another embodiment, the method includes initiating a registration procedure for mobility and periodic registration update in response to determining that at least one timer is not running after the completion of the generic UE configuration update procedure.

In an embodiment, the message includes at least one of a configuration update command message and a deregistration request message, where the deregistration request message indicates the re-registration required field, and where the configuration update command message indicates the registration required field.

In an embodiment, the configuration update command message indicates the registration requested field in a registration requested bit of a configuration update indication information element (IE), and wherein the configuration update command message comprises at least one of an allowed Network Slice Selection Assistance Information (NSSAI), a configured NSSAI and a network slicing subscription change indication or contains no other parameters.

In an embodiment, the initial registration or the registration procedure for mobility and periodic registration update is initiated over at least one of a 3GPP access and a non-3GPP access.

Accordingly, the embodiments herein provide a UE including a PLMN selection procedure controller coupled with a processor and a memory. The PLMN selection procedure controller is configured to receive a message indicating one of a re-registration required field and a registration required field. Further, the PLMN selection procedure controller is configured to complete one of a de-registration procedure and a generic UE configuration update procedure based on the message. Further, the PLMN selection procedure controller is configured to determine whether at least one timer is running after the completion of one of the de-registration procedure or the generic UE configuration update procedure, and a release of an existing NAS signalling connection. In an embodiment, the PLMN selection procedure controller is configured to stop the at least one timer and attempt to obtain at least one service on a higher priority PLMN on a 3^{rd} Generation Partnership Project (3GPP) access in response to determining that at least one timer is running after the completion of one of the de-registration procedure and the generic UE configuration update procedure. In another embodiment, the PLMN selection procedure controller is configured to initiate an initial registration in response to determining that at least one timer is not running after the completion of the de-registration procedure. In another embodiment, the PLMN selection procedure controller is configured to initiate a registration procedure for mobility and periodic registration update in response to determining that at least one timer is not running after the completion of the generic UE configuration update procedure.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 illustrates an example scenario, wherein successive security checks may cause the PLMN to be of a lower priority, according to prior arts;

FIG. 2 illustrates an example scenario, wherein the SoR CMCI configuration is attempted, when there is no CMCI information, according to prior arts;

FIG. 3 illustrates a scenario, wherein a network initiated deregistration message indicating “re-registration required” and the de-registration request is for 3GPP access or 3GPP access and non-3GPP access delays a higher priority PLMN selection, according to prior arts;

FIG. 4 illustrates a scenario, wherein a Network initiated Configuration Update command and “registration requested” was indicated in the Registration requested bit of the Configuration update indication IE in the CONFIGURATION UPDATE COMMAND message delays a higher priority PLMN selection, according to prior arts;

FIG. 5 illustrates a method for maintaining priority of VPLMNs in wireless communication networks, due to multiple SoR security check failures by enabling the UE to consider the last SoR security check status, according to embodiments as disclosed herein;

FIG. 6A illustrates various hardware components of a network entity, according to the embodiments as disclosed herein;

FIG. 6B illustrates various hardware components of a UE, according to the embodiments as disclosed herein;

FIG. 6C illustrates various hardware components of a base station, BS, according to the embodiments as disclosed herein;

FIG. 7 illustrates flow chart of method for maintaining priority of a VPLMN during a PLMN selection procedure, according to the embodiments as disclosed herein;

FIG. 8 illustrates flow chart of method for managing SoR CMCI configuration in a wireless communication network, when there is no CMCI information present, according to embodiments as disclosed herein;

FIG. 9 illustrates flow chart of method for handling network initiated procedure(s) during Tsor-cm timer, according to the embodiments as disclosed herein;

FIG. 10 illustrates a scenario, wherein the UE triggers a higher priority PLMN search after receiving a deregistration message indicating “re-registration required” and the de-registration request is for 3GPP access or 3GPP access and non-3GPP access from the network, according to embodiments as disclosed herein;

FIG. 11 illustrates a scenario, wherein the UE triggers a registration request after receiving a deregistration message indicating “re-registration required” and the de-registration request is for 3GPP access or 3GPP access and non-3GPP access from the network, according to embodiments as disclosed herein;

FIG. 12 illustrates a scenario, wherein the UE triggers a higher priority PLMN search after receiving a Network initiated Configuration Update command and “registration requested” was indicated in the Registration requested bit of the Configuration update indication IE in the CONFIGURATION UPDATE COMMAND message, according to embodiments as disclosed herein; and

FIG. 13 illustrates a scenario, wherein the UE triggers a registration request after receiving a Network initiated Configuration Update command and “registration requested” was indicated in the Registration requested bit of the Configuration update indication IE in the CONFIGURATION UPDATE COMMAND message, according to embodiments as disclosed herein.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, denotes to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” denotes any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, denotes that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

The embodiments of the disclosure will be described in detail below, and the examples of the embodiments are illustrated in the accompanying drawings, throughout which the same or similar reference numerals refer to the same or similar elements or elements having the same or similar functions. The embodiments to be described below with reference to the accompanying drawings are exemplary, and are only used for explaining the disclosure, rather than being construed as limiting the disclosure.

It should be understood by those skilled in the art that, as used herein, the singular form “a”, “an” or “the” may be intended to include plural forms as well, unless otherwise stated. It should be further understood that the term “comprise/comprising” used in the specification of the disclosure specifies the presence of the stated features, integers, steps, operations, elements and/or components, but not exclusive of the presence or addition of one or more other features, integers, steps, operations, elements, components and/or combinations thereof. It should be understood that, when a component is referred to as being “connected” or “coupled” to another component, this element may be directly connected or coupled to the another element, or there may be intervening elements therebetween. In addition, as used herein, the “connection” or “coupling” may comprise wireless connection or wireless coupling. As used herein, the term “and/or” comprises all or any of one or more associated listed items or combinations thereof.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

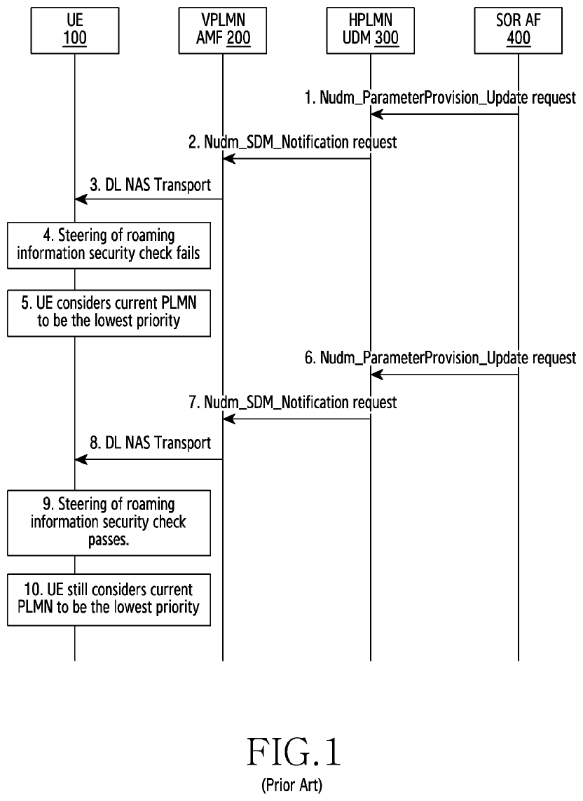

FIGS. 1 to 13 discussed below and various embodiments used for describing the principle of the disclosure in this patent document are merely illustrative, and may not be construed as limiting the scope of the disclosure in any way. It should be understood by those skilled in the art that the principle of the disclosure can be implemented in systems or devices in any suitable arrangement.

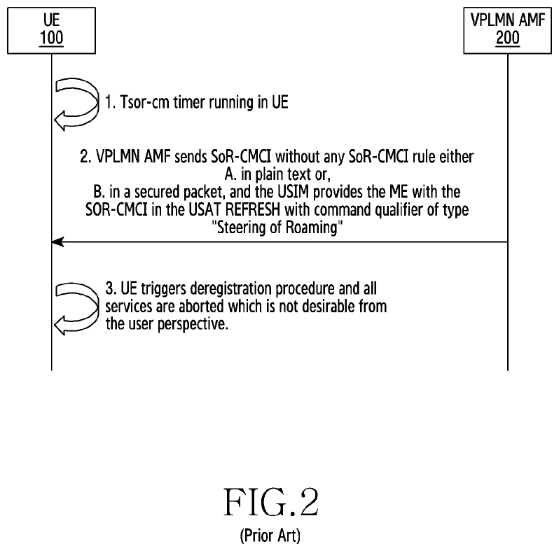

FIG. 1 illustrates an example scenario, wherein successive security checks may cause the Visited PLMN (VPLMN) to be of a lower priority, according to prior arts. As depicted in FIG. 2, wherein successive security checks may cause the Public Land Mobile network (PLMN) to be of a lower priority. In step 1, the SOR AF (400) sends Nudm_ParameterProvision_Update request to the HPLMN UDM (300) to trigger the update of the UE (100) with the new list of preferred PLMN/access technology combinations and/or the SOR-CMCI, if any, or a secured packet for the UE (100) identified by the SUPI.

In step 2, the Unified Data Management (UDM) (300) notifies the changes of the user profile to the affected Access and Mobility Management Function (AMF) (200) by the means of invoking Nudm_SDM_Notification service operation. The Nudm_SDM_Notification service operation contains the steering of roaming information that needs to be delivered transparently to the UE (100) over NAS within the Access and Mobility Subscription data.

In step 3, the AMF (200) sends the DL NAS TRANSPORT message to the served UE (100). The AMF (200) includes in the DL NAS TRANSPORT message the steering of roaming information received from the UDM (300).

In step 4, on receiving the steering of roaming information, the UE (100) may perform the security check on the steering of roaming information included in the DL NAS TRANSPORT message or for example, registration accept message or any other NAS message to verify that the steering of roaming information is provided by the HPLMN.

In step 5, if the selected PLMN is the VPLMN, the security check is not successful and the UE (100) is in an automatic network selection mode, then the UE (100) may wait until the UE (100) moves to the idle mode or the 5GMM-CONNECTED mode with the RRC inactive indication before attempting to obtain service on a higher priority PLMN by acting as if timer T that controls periodic attempts has expired, with an exception that the current PLMN is considered as lowest priority. The UE (100) considers the current PLMN as the lowest priority PLMN because the current PLMN is considered as malicious PLMN which has attempted to change the information sent to the UE (100) from the HPLMN.

In one scenario, as depicted in step 6, before the UE (100) moves to idle mode or 5GMM-CONNECTED mode with RRC inactive indication, the SOR AF (400) sends the Nudm_ParameterProvision_Update request to the HPLMN UDM (300) to trigger the update of the UE (100) with the new list of preferred PLMN/access technology combinations and/or the SOR-CMCI, if any, or a secured packet for a UE (100) identified by SUPI.

In step 7, as a result, the UDM (300) notifies the changes of the user profile to the affected AMF (200) by the means of invoking Nudm_SDM_Notification service operation. The Nudm_SDM_Notification service operation contains the steering of roaming information that needs to be delivered transparently to the UE (100) over the NAS within the Access and Mobility Subscription data.

In step 8, the AMF (200) sends the DL NAS TRANSPORT message or for example, registration accept message or any other NAS message to the served UE (100). The AMF (200) includes in the DL NAS TRANSPORT message or for example, registration accept message or any other NAS message the steering of roaming information received from the UDM (300).

In step 9, on receiving the steering of roaming information, the UE (100) may perform a security check on the steering of roaming information included in the NAS message for example DL NAS TRANSPORT message or registration accept message to verify that the steering of roaming information is provided by HPLMN.

In step 10, even though the UE (100) passes the security check this time, the UE (100) may still attempt to obtain service on a higher priority PLMN by acting as if timer T that controls periodic attempts has expired, with an exception that the current (V)PLMN is considered as lowest priority, as soon as the UE (100) moves to idle mode or 5GMM-CONNECTED mode with RRC inactive indication, while the UE (100) is in automatic network selection mode.

Thus the VPLMN is unnecessarily considered as malicious and treated as lower priority PLMN by the UE, the prior art misses the fact that sometimes due to genuine issues at the HPLMN the received packet can be erroneous and under such cases how may UE identity and react is a problem worth solving or at least to provide an alternate mechanism to handle it.

FIG. 2 illustrates an example scenario, wherein the SoR CMCI configuration is attempted, when there is no CMCI information, according to prior arts. In step 1, Tsor-cm timer is running in the UE (100). In step 2, the VPLMN AMF (200) sends SoR-CMCI without any SoR-CMCI rule either in plain text or, —in a secured packet, and the USIM provides the ME with the SOR-CMCI in the USAT REFRESH with command qualifier of type “Steering of Roaming”. In step 3, the UE (100) triggers the deregistration procedure and all services are aborted, which is not desirable from the user perspective.

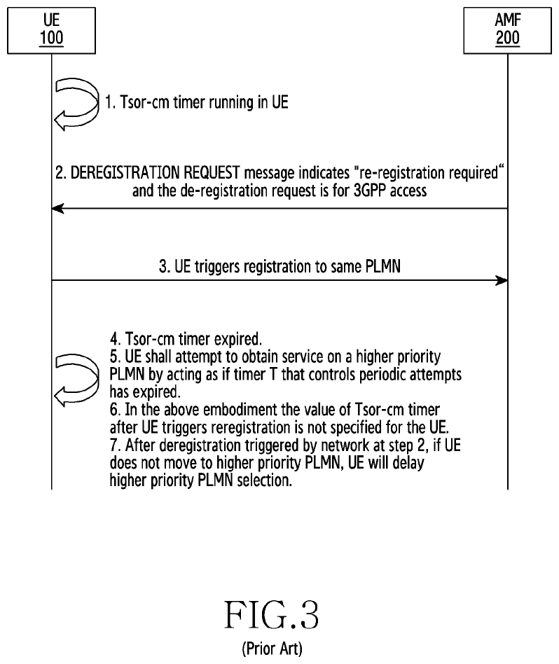

FIG. 3 illustrates a scenario, wherein a network initiated deregistration message indicating “re-registration required” and the de-registration request is for 3GPP access or 3GPP access and non-3GPP access delays a higher priority PLMN selection. In step 1, Tsor-cm timer is running in the UE (100). In step 2, the AMF (200) sends a DEREGISTRATION REQUEST message, which indicates “re-registration required” and the de-registration request is for 3GPP access or 3GPP access and non-3GPP access. In step 3, the UE (100) triggers registration to the same PLMN. In step 4, the Tsor-cm timer expires. In step 5, the UE (100) attempts to obtain service on a higher priority PLMN by acting as if timer T that controls periodic attempts has expired. In this scenario, the value of the Tsor-cm timer after the UE triggers reregistration has not been specified for the UE (100). After deregistration has been triggered by network at step 2, if the UE (100) does not move to higher priority PLMN, the UE (100) may delay higher priority PLMN selection.

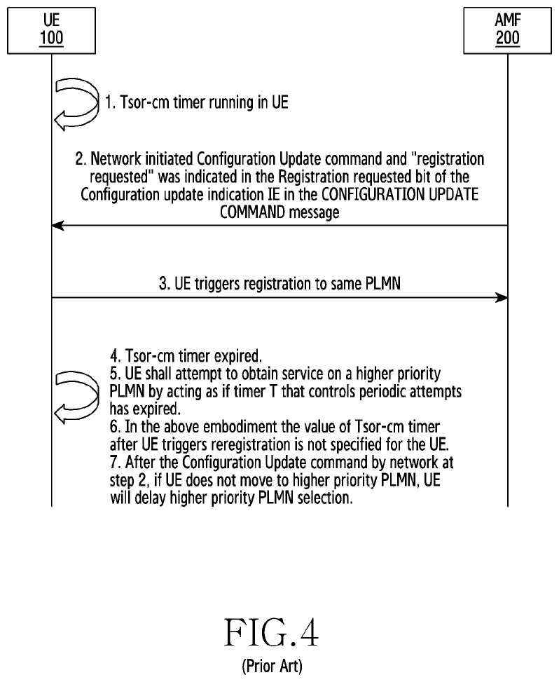

FIG. 4 illustrates a scenario, wherein a Network initiated Configuration Update command and “registration requested” was indicated in the Registration requested bit of the Configuration update indication IE in the CONFIGURATION UPDATE COMMAND message delays a higher priority PLMN selection. In step 1, Tsor-cm timer is running in the UE (100). In step 2, the network initiated Configuration Update command and “registration requested” was indicated in the Registration requested bit of the Configuration update indication IE in the CONFIGURATION UPDATE COMMAND message. In step 3, the UE (100) triggers registration to the same PLMN. In step 4, the Tsor-cm timer has expired. In step 5-step 7, the UE (100) may attempt to obtain service on a higher priority PLMN by considering that the timer T that controls periodic attempts has expired. In this scenario, the value of the Tsor-cm timer after the UE (100) triggers reregistration is not specified for the UE (100). After the Configuration Update command by the network at step 2, if the UE (100) does not move to higher priority PLMN, the UE (100) may delay higher priority PLMN selection.

That is, in summary, as per the prior art there are two requirements:
a) When a UE is running Tsor-CM timers and the UE enters an IDLE state then the UE stop respective timers and may trigger higher priority PLMN search to select higher priority PLMN.
b) When the UE is in connected the UE receives a NAS message for e.g. deregistration with a “re-registration required” indication. In this case when the UE enters IDLE state, the UE may trigger registration procedure again.

Lets consider for case “b” timer Tsor-CM timer was also running, and UE receives deregistration with “re-registration required” indication, now after UE goes to IDLE state, UE may end up performing registration procedure following the UE requirement of “b”. Given registration procedure is lengthy and later UE may start data transmission, UE is no more running Tsor-CM timers too. Thus UE may be stuck with current VPLMN and it may not select higher priority PLMN even if it enters IDLE state in future.

This may cause revenue loss to the home operator as the UE is not moving to preferred PLMN in time and the preferred services to the UE may not be received. This is opening up a security issue in which malicious VPLMN can make UE to remain stuck with VPLMN by sending deregistration “registration required” flag to the UE following up sending of steering of roaming information.

The principal object of the embodiments herein is to disclose systems and methods to maintain priority of VPLMNs in wireless communication networks, due to multiple SoR security check failures by enabling the UE to consider the last SoR security check status.

Another object of the embodiments herein is to disclose systems and methods to handle/manage SoR CMCI configuration with no CMCI information.

Another object of the embodiments herein is to disclose systems and methods for handling network initiated procedure(s) during Tsor-cm timer.

Another object of the embodiments herein is to disclose systems and methods to handle network initiated procedure(s) during Tsor-cm timer, wherein the UE triggers a higher priority PLMN search after receiving a deregistration message indicating “re-registration required” and the de-registration request is for 3GPP access or 3GPP access and non-3GPP access from the network.

Another object of the embodiments herein is to disclose systems and methods to handle network initiated procedure(s) during Tsor-cm timer, wherein the UE triggers a registration request after receiving a deregistration message indicating “re-registration required” and the de-registration request is for 3GPP access or 3GPP access and non-3GPP access from the network.

Another object of the embodiments herein is to disclose systems and methods to handle network initiated procedure(s) during Tsor-cm timer, wherein the UE triggers a higher priority PLMN search after receiving Network initiated Configuration Update command and “registration requested” was indicated in the Registration requested bit of the Configuration update indication IE in the CONFIGURATION UPDATE COMMAND message.

Another object of the embodiments herein is to disclose systems and methods to handle network initiated procedure(s) during Tsor-cm timer, wherein UE triggers a registration request after receiving a Network initiated Configuration Update command and “registration requested” was indicated in the Registration requested bit of the Configuration update indication IE in the CONFIGURATION UPDATE COMMAND message.

The embodiments herein achieve method for maintaining priority of a VPLMN during a PLMN selection procedure. The method includes determining, by a UE, that a first SOR security check failure occurs upon receiving a first SOR information at the UE. The UE is configured with a pre-configured priority for the VPLMN. Further, the method includes starting, by the UE, a timer with a value included in a steering of roaming connected mode control information (SOR-CMCI) in response to determination. Further, the method includes determining, by the UE, whether the UE has entered a connectivity state and a second SOR information is received before the UE entering into the state. In an embodiment, the method includes ignoring the pre-configured priority for the VPLMN and considering the VPLMN as a lowest priority in response to determining that the UE has entered into the state and the second SOR information is not received before the UE entering into the state or the received second SOR information security check is not successful. In another embodiment, the method includes considering a priority of the VPLMN as the pre-configured priority by not considering the VPLMN as a lowest priority and stopping the timer associated with the “first SOR security check not successful” in response to determining that the UE receives the second SOR information and a second SOR security check is successful before the UE enters into the connectivity state.

The provided methods can be used to determine if the VPLMN is malicious, or one of the SOR security check failed due to HPLMN errors etc., and maintain priority of VPLMNs in the wireless communication networks, due to multiple SoR security check failures by enabling the UE to consider the last SoR security check status or at least one of the SoR security check status.

Accordingly, the embodiments herein provide systems and methods for managing SoR CMCI configuration in a wireless communication network, when there is no CMCI information present.

The embodiments herein achieve systems and methods to handle network initiated procedure(s) during ongoing Tsor-cm timer. The UE can trigger a higher priority PLMN search after receiving a deregistration message indicating “re-registration required” and the de-registration request is for 3GPP access or 3GPP access and non-3GPP access from the network. The UE can trigger a registration request after receiving a deregistration message indicating “re-registration required” and the de-registration request is for 3GPP access or 3GPP access and non-3GPP access from the network. The UE can trigger a higher priority PLMN search after receiving a Network initiated Configuration Update command and “registration requested” was indicated in the Registration requested bit of the Configuration update indication IE in the CONFIGURATION UPDATE COMMAND message. The UE can trigger a registration request after receiving a Network initiated Configuration Update command and “registration requested” was indicated in the Registration requested bit of the Configuration update indication IE in the CONFIGURATION UPDATE COMMAND message.

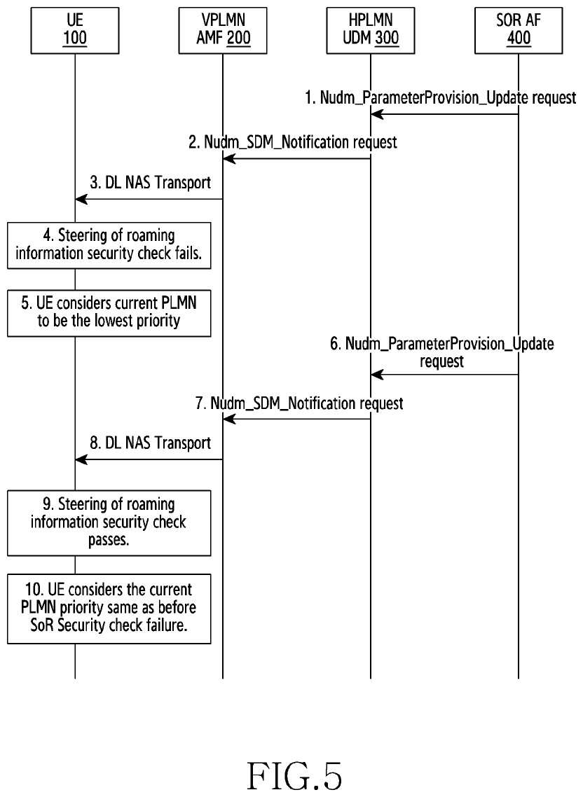

Referring now to the drawings, and more particularly to FIG. 5 through FIG. 13, where similar reference characters denote corresponding features consistently throughout the figures, there are shown at least one embodiment.

The following abbreviations have been used herein in the patent disclosure:
a) SoR: Steering of Roaming
b) SoR-AF: Steering of Roaming application function
c) VPLMN: Visited PLMN
d) HPLMN: Home PLMN
e) UDM: Unified Data Management
f) AMF: Access and Mobility Management Function
g) UL: Uplink
h) DL: Downlink
i) SoR-CMCI: Steering of roaming connected mode control information
j) TAI: Tracking Area Identity
k) PDU: Packet Data Unit
l) 3GPP: 3^{rd} Generation Partnership Project
m) SR: Service Request

FIG. 5 illustrates a method for maintaining priority of VPLMNs in wireless communication networks, due to multiple SoR security check failures by enabling the UE (100) to consider the last SoR security check status. In step 1, the SOR AF (400) sends a Nudm_ParameterProvision_Update request to the HPLMN UDM (300) to trigger the update of the UE (100) with the new list of preferred PLMN/access technology combinations and/or the SOR-CMCI, if any, or the secured packet for the UE (100) identified by SUPI.

In step 2, the UDM (300) notifies the changes of the user profile to the affected AMF (200) by the means of invoking Nudm_SDM_Notification service operation. The Nudm_SDM_Notification service operation contains the steering of roaming information that needs to be delivered transparently to the UE (100) over NAS within the Access and Mobility Subscription data.

In step 3, the AMF (200) sends a DL NAS TRANSPORT message to the served UE (100). The AMF (200) includes the steering of roaming information received from the UDM (300) in the DL NAS TRANSPORT message.

In step 4, on receiving the steering of roaming information, the UE (100) may perform a security check on the steering of roaming information included in the DL NAS TRANSPORT message to verify that the steering of roaming information is provided by HPLMN.

In step 5, If the selected PLMN is a VPLMN, the security check is not successful and the UE (100) is in automatic network selection mode, then the UE (100) may wait until it moves to idle mode or 5GMM-CONNECTED mode with RRC inactive indication (see 3GPP TS 24.501) before attempting to obtain service on a higher priority PLMN by acting as if timer T that controls periodic attempts has expired, with an exception that the current PLMN is considered as lowest priority.

In step 6, in one scenario, before the UE (100) moves to idle mode or 5GMM-CONNECTED mode with RRC inactive indication, the SOR AF (400) sends Nudm_ParameterProvision_Update request to the HPLMN UDM (300) to trigger the update of the UE (100) with the new list of preferred PLMN/access technology combinations and the SOR-CMCI, if any, or a secured packet for a UE (100) identified by SUPI.

In step 7, as a result, the UDM (300) notifies the changes of the user profile to the affected AMF (200) by the means of invoking Nudm_SDM_Notification service operation. The Nudm_SDM_Notification service operation contains the steering of roaming information that needs to be delivered transparently to the UE (100) over NAS within the Access and Mobility Subscription data.

In step 8, the AMF (200) sends a DL NAS TRANSPORT message to the served UE (100). The AMF (200) includes the steering of roaming information received from the UDM (300) in the DL NAS TRANSPORT message.

In step 9, on receiving the steering of roaming information, the UE (100) may perform a security check on the steering of roaming information included in the DL NAS TRANSPORT message to verify that the steering of roaming information is provided by HPLMN.

In step 10, as the UE (100) passes the security check, this time, the UE (100) may regain the original priority of the current PLMN (PLMN priority before SoR Security check failure) i.e. the PLMN is not considered as lowest priority PLMN and optionally the UE (100) may wait until it moves to idle mode or 5GMM-CONNECTED mode with RRC inactive indication before attempting to obtain service on a higher priority PLMN, by acting as if timer T that controls periodic attempts has expired; i.e., the UE (100) may not consider the current camped VPLMN as lowest priority VPLMN; i.e., the UE (100) may discard from its memory that SOR security check had failed in the past and may behave as if the SoR security check was successful.

In step 11, as per the provided solution, the UE (100) may consider the last received SoR Security check status before setting priority of the current PLMN.

In an embodiment, the first time received information is referred to herein as first SOR information and the second time received SOR information to the UE (100) as the second SOR information (or the last received SOR information without taking number into account i.e., it can be third, fourth or so on). In general, the last time received SOR information if the security check is successful in the same connected mode (i.e. using the same NAS signaling connection) i.e. before the UE (100) goes to IDLE mode or 5GMM-CONNECTED mode with RRC inactive indication, then the UE (100) may discard any information it has stored about SOR security check failure of past received SOR information over the same NAS signalling connection and when the UE (100) goes to IDLE state or 5GMM-CONNECTED mode with RRC inactive indication, the UE (100) may not make (or consider) the current VPLMN as lowest priority VPLMN.

If the selected PLMN is the VPLMN, the security check of the last received steering of roaming (SOR) information is not successful and the UE (100) is in automatic network selection mode, then the UE (100) may wait until it moves to idle mode or 5GMM-CONNECTED mode with RRC inactive indication before attempting to obtain service on a higher priority PLMN by acting as if timer T that controls periodic attempts has expired, with an exception that the current PLMN is considered as lowest priority. If the selected PLMN is the VPLMN and the UE (100) has an established emergency PDU session, then the UE (100) may attempt to perform the PLMN selection after the emergency PDU session is released.

Upon receiving the steering of roaming information, the UE (100) may perform a security check on the steering of roaming information included in the DL NAS TRANSPORT message or registration accept message or any other NAS message to verify that the steering of roaming information is provided by HPLMN, and if the security check of the last received SOR information was successful.

If the UE (100) is in automatic network selection mode and the selected PLMN is a VPLMN, then:
a) if the UE (100) is configured with the SOR-CMCI or received the SOR-CMCI over N1 NAS signalling, the UE (100) may apply the actions in for the case when it is configured for SOR-CMCI, i.e. start the respective Tsor-CM timers based on the services ongoing and on the expiry of the Tsor-CM timers UE can trigger procedure to move to the IDLE state; or
b) the UE (100) may wait until it moves to the idle mode or the 5GMM-CONNECTED mode with RRC inactive indication before attempting to obtain service on a higher priority PLMN by acting as if timer T that controls periodic attempts has expired.

The UE does not consider the current PLMN as lowest priority PLMN.

If the selected PLMN is a VPLMN and the UE (100) has an established emergency PDU session, then the UE (100) may attempt to perform the PLMN selection subsequently after the emergency PDU session is released, if the UE (100) is in automatic network selection mode.

When first SOR information is received, if the UE (100) encounters SOR security check not successful on the received steering of roaming information, and a matching criterion “SOR security check not successful” is included in the SOR-CMCI stored in the non-volatile memory of the ME, then the UE (100) may:
a) if the timer value is not zero, start an associated Tsor-cm timer with the value included in the SOR-CMCI;
b) stop all other running Tsor-cm timers (if any); and
c) not start any new Tsor-cm timer while Tsor-cm timer associated with “SOR security check not successful” criterion is running.

Now while this Tsor-cm timer associated with “SOR security check not successful” criterion is running the UE (100) receives second SOR information and if this time the security check is successful then UE (100) may stop the Tsor-cm timer associated with “SOR security check not successful” criterion. The UE (100) may start all other Tsor-cm timers based on the SOR-CMCI configuration of other criterion i.e. a criterion of one of the following types:
a) PDU session attribute type criterion;
b) service type criterion; or
c) match all type criterion; and

If the timer value is not zero, an associated timer Tsor-cm is started with the value
a) included in the SOR-CMCI; or
b) included in the SOR-CMCI subtracted with time the Tsor-cm timer associated with “SOR security check not successful” criterion was running. If end value is negative, then the timer value is set to zero; or
c) if a matching criterion is found and the value of Tsor-cm timer in the SOR-CMCI is other than infinity and is smaller than the current value of the running Tsor-cm timer for the associated PDU session or service, then the Tsor-cm timer value for the associated PDU session or service may be replaced with the value in the new SOR-CMCI without stopping and restarting the timer;

When the UE (100) determines that no Tsor-cm timer is running, the last running Tsor-cm timer is stopped due to release of the associated PDU sessions or stop of the associated services, or the last running Tsor-cm timer expires, if:
a) the UE (100) has a list of available and allowable PLMNs in the area and based on this list or any other implementation specific means, the UE (100) determines that there is a higher priority PLMN than the selected VPLMN; or
b) ii) the UE (100) does not have a list of available and allowable PLMNs in the area and is unable to determine whether there is a higher priority PLMN than the selected VPLMN using any other implementation specific means;

then if the UE (100) is in 5GMM-CONNECTED mode, the UE (100) may perform the deregistration procedure that releases all the established PDU sessions and services, if any, and once the UE (100) enters idle mode it may attempt to obtain service on a higher priority PLMN as specified in by acting as if timer T that controls periodic attempts has expired.

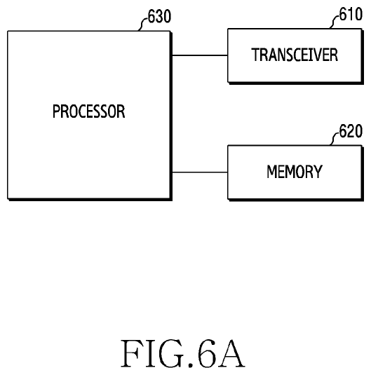

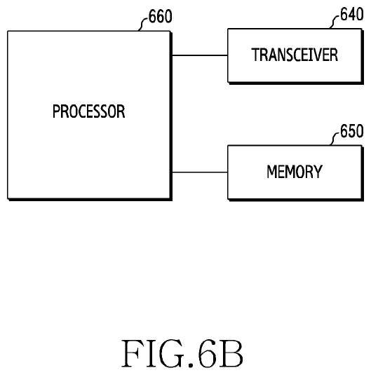

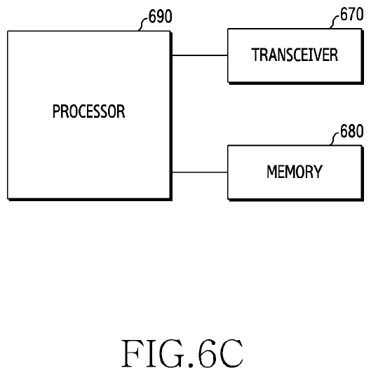

FIG. 6A illustrates various hardware components of a network entity, according to the embodiments as disclosed herein.

Referring to FIG. 6A, the network entity includes a transceiver (610), a memory (620), and a processor (630). The transceiver (610), the memory (620), and the processor (630) of the network entity may operate according to a communication method of the network entity described above. However, the components of the terminal are not limited thereto. For example, the network entity may include fewer or a greater number of components than those described above. In addition, the processor (630), the transceiver (610), and the memory (620) may be implemented as a single chip. Also, the processor (630) may include at least one processor.

The network entity includes at least one entity of a core network. For example, the network entity includes an AMF, a session management function (SMF), a policy control function (PCF), a network repository function (NRF), a user plane function (UPF), a network slicing selection function (NSSF), an authentication server function (AUSF), a UDM and a network exposure function (NEF), but the network entity is not limited thereto.

The transceiver (610) collectively refers to a network entity receiver and a network entity transmitter, and may transmit/receive a signal to/from a base station or a UE. The signal transmitted or received to or from the base station or the UE may include control information and data. In this regard, the transceiver (610) may include an RF transmitter for up-converting and amplifying a frequency of a transmitted signal, and an RF receiver for amplifying low-noise and down-converting a frequency of a received signal. However, this is only an example of the transceiver (610) and components of the transceiver (610) are not limited to the RF transmitter and the RF receiver.

The transceiver (610) may receive and output, to the processor (630), a signal through a wireless channel, and transmit a signal output from the processor (630) through the wireless channel.

The memory (620) may store a program and data required for operations of the network entity. Also, the memory (620) may store control information or data included in a signal obtained by the network entity. The memory (620) may be a storage medium, such as a ROM, a RAM, a hard disk, a CD-ROM, and a DVD, or a combination of storage media.

The processor (630) may control a series of processes such that the network entity operates as described above. For example, the transceiver (610) may receive a data signal including a control signal, and the processor (630) may determine a result of receiving the data signal.

FIG. 6B illustrates various hardware components of the UE (100), according to the embodiments as disclosed herein. In an embodiment, the UE (100) includes a processor (660), a transceiver (640), a memory (650). The processor (660) is coupled with the transceiver (610), the memory (620). The UE further includes a PLMN selection procedure controller.

Referring to FIG. 6B, the PLMN selection procedure controller determines that the first SOR security check failure occurs upon receiving the first SOR information at the UE (100). The UE (100) is configured with the pre-configured priority for the VPLMN. In response determination, the PLMN selection procedure controller starts the timer with the value included in the SOR-CMCI. Further, the PLMN selection procedure controller determines whether the UE (100) has entered into a state and the second SOR information is received before the UE (100) entering into the state. In an embodiment, the PLMN selection procedure controller ignores the pre-configured priority for the VPLMN and considers the VPLMN as the lowest priority in response to determine that the UE (100) has entered into the state and the second SOR information is not received before the UE (100) entering into the state or the received second SOR information security check is not successful. In another embodiment, in response to determining that the UE (100) receives the second SOR information and the second SOR security check is successful before the UE (100) enters into the state, the PLMN selection procedure controller considers the priority of the VPLMN as the pre-configured priority by not considering the VPLMN as a lowest priority and stops the timer associated with the “first SOR security check not successful”. The state can be, for example, but not limited to an IDLE state and a 5GMM-CONNECTED mode with a radio resource control (RRC) inactive indication state.

In an embodiment, the timer with the value is associated with the “SOR security check not successful” is included in the SOR-CMCI stored at the UE (100). The timer comprises a Tsor-cm timer.

In an embodiment, at least one of the first SOR information and the second SOR information are provided in a downlink Non-access stratum (DL NAS) transport message to the UE (100). The pre-configured priority of the (V)PLMN is in the below order configured in the UE (100) (either in the ME or the USIM):
i) either the HPLMN (if the EHPLMN list is not present or is empty) or the highest priority EHPLMN that is available (if the EHPLMN list is present);
ii) each PLMN/access technology combination in the “User Controlled PLMN Selector with Access Technology” data file in the SIM (in priority order);
iii) each PLMN/access technology combination in the “Operator Controlled PLMN Selector with Access Technology” data file in the SIM (in priority order) or stored in the ME (in priority order);
iv) other PLMN/access technology combinations with received high quality signal in random order;
Please note that high quality signal is defined in the appropriate AS specification.
v) other PLMN/access technology combinations in order of decreasing signal quality.

The UE (100) enters IDLE state when network releases NAS signaling connection or the UE enters 5GMM-CONNECTED mode with RRC inactive indication state when UE receives an access stratum (AS) message like RRC connection release with an indication to enter the 5GMM-CONNECTED mode with RRC inactive indication state. In short UE enters this state when it receives RRC connection release or NAS signalling connection release.

In another embodiment, the PLMN selection procedure controller receives the message indicating one of the re-registration required field and the registration required field. In an embodiment, the message includes at least one of a configuration update command message and a deregistration request message, where the deregistration request message indicates the re-registration required field, and where the configuration update command message indicates the registration required field. In an embodiment, the configuration update command message indicates the registration requested field in a registration requested bit of a configuration update indication information element (IE), and wherein the configuration update command message comprises at least one of an allowed Network Slice Selection Assistance Information (NSSAI), a configured NSSAI and a network slicing subscription change indication or contains no other parameters.

Based on the message, the PLMN selection procedure controller is configured to complete one of a de-registration procedure and a generic UE configuration update procedure. Further, the PLMN selection procedure controller is configured to determine whether at least one timer is running after the completion of one of the de-registration procedure or the generic UE configuration update procedure, and a release of an existing NAS signalling connection. In an embodiment, in response to determining that at least one timer is running after the completion of one of the de-registration procedure and the generic UE configuration update procedure, the PLMN selection procedure controller is configured to stop the at least one timer and attempt to obtain at least one service on a higher priority PLMN on a 3^{rd} Generation Partnership Project (3GPP) access. In another embodiment, in response to determining that at least one timer is not running after the completion of the de-registration procedure, the PLMN selection procedure controller is configured to initiate an initial registration. In another embodiment, the PLMN selection procedure controller is configured to initiate a registration procedure for mobility and periodic registration update in response to determining that at least one timer is not running after the completion of the generic UE configuration update procedure. In an embodiment, the initial registration or the registration procedure for mobility and periodic registration update is initiated over at least one of a 3GPP access and a non-3GPP access.

The PLMN selection procedure controller is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (660) is configured to execute instructions stored in the memory (650) and to perform various processes. The transceiver (640) is configured for communicating internally between internal hardware components and with external devices via one or more networks. The memory (650) also stores instructions to be executed by the processor (660). The memory (650) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (650) may, in some examples, be considered a non-transitory storage medium. The term “non-transitory” may indicate that the storage medium is not embodied in a carrier wave or a propagated signal. However, the term “non-transitory”should not be interpreted that the memory (650) is non-movable. In certain examples, a non-transitory storage medium may store data that can, over time, change (e.g., in Random Access Memory (RAM) or cache).

Although the FIG. 6B illustrates various hardware components of the UE (100) but it is to be understood that other embodiments are not limited thereon. In other embodiments, the UE (100) may include less or more number of components. Further, the labels or names of the components are used only for illustrative purpose and does not limit the scope of the present disclosure. One or more components can be combined together to perform same or substantially similar function in the UE (100).

FIG. 6C illustrates various hardware components of a base station, BS, according to the embodiments as disclosed herein.

Referring to FIG. 6C, the base station according to an embodiment may include a transceiver (670), a memory (680), and a processor (690). The transceiver (670), the memory (680), and the processor (690) of the base station may operate according to a communication method of the base station described above. However, the components of the base station are not limited thereto. For example, the base station may include more or fewer components than those described above. In addition, the processor (690), the transceiver (670), and the memory (680) may be implemented as a single chip. Also, the processor (690) may include at least one processor.

The transceiver (670) collectively refers to a base station receiver and a base station transmitter, and may transmit/receive a signal to/from a terminal (UE) or a network entity. The signal transmitted or received to or from the terminal or a network entity may include control information and data. The transceiver (670) may include a RF transmitter for up-converting and amplifying a frequency of a transmitted signal, and a RF receiver for amplifying low-noise and down-converting a frequency of a received signal. However, this is only an example of the transceiver (670) and components of the transceiver (670) are not limited to the RF transmitter and the RF receiver.

Also, the transceiver (670) may receive and output, to the processor (690), a signal through a wireless channel, and transmit a signal output from the processor (690) through the wireless channel.

The memory (680) may store a program and data required for operations of the base station. Also, the memory (680) may store control information or data included in a signal obtained by the base station. The memory (680) may be a storage medium, such as read-only memory (ROM), random access memory (RAM), a hard disk, a CD-ROM, and a DVD, or a combination of storage media.

The processor (690) may control a series of processes such that the base station operates as described above. For example, the transceiver (670) may receive a data signal including a control signal transmitted by the terminal, and the processor (690) may determine a result of receiving the control signal and the data signal transmitted by the terminal.

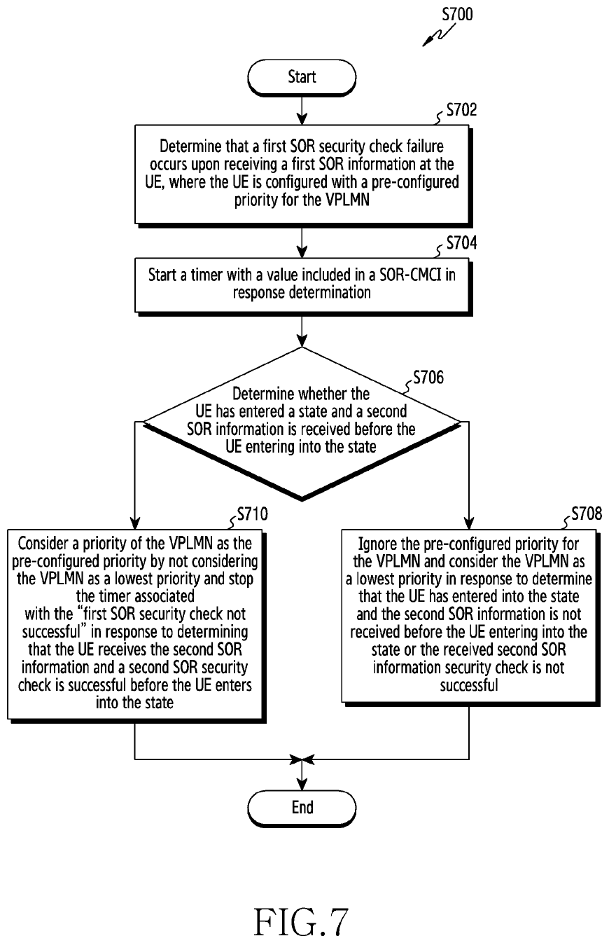

FIG. 7 illustrates flow chart (S700) of method for maintaining priority of the VPLMN during the PLMN selection procedure, according to the embodiments as disclosed herein. The operations (S702-S710) are handled by the PLMN selection procedure controller.

At S702. The method includes determining that the first SOR security check failure occurs upon receiving a first SOR information at the UE (100). The UE (100) is configured with the pre-configured priority for the VPLMN. At S704, the method includes starting the timer with the value included in the SOR-CMCI in response to determination. At S706, the method includes determining whether the UE (100) has entered the state and the second SOR information is received before the UE (100) entering into the state. At S708, the method includes ignoring the pre-configured priority for the VPLMN and considering the VPLMN as the lowest priority in response to determining that the UE (100) has entered into the state and the second SOR information is not received before the UE (100) entering into the state or the received second SOR information security check is not successful. At S710, the method includes considering the priority of the VPLMN as the pre-configured priority and stopping the timer associated with the “first SOR security check not successful” in response to determining that the UE (100) receives the second SOR information and a second SOR security check is successful before the UE (100) enters into the state.

The UE (100) can consider the VPLMN as the lowest priority VPLMN by maintaining (i.e. including) in the list of “PLMNs where registration was aborted due to SOR” or by memorizing it or using a flag and etc. mechanisms.

The illustration of the present disclosure in this embodiment is with respect to the PLMN but it can be applied even to SNPN.

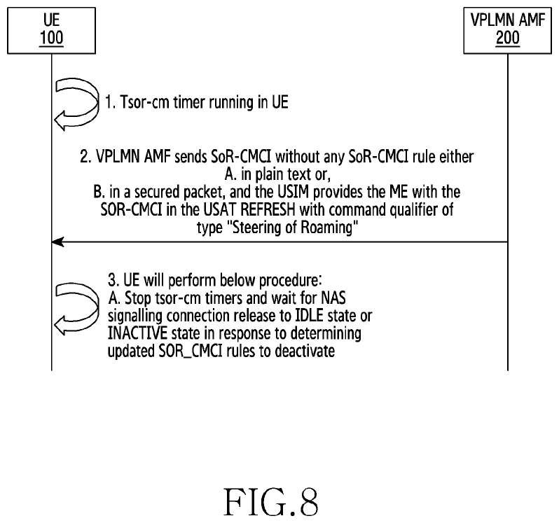

FIG. 8 illustrates flowchart of depicting a method for managing SoR CMCI configuration in the wireless communication network, when there is no CMCI information present (i.e., When the SOR-CMCI received by the UE (100) over N1 NAS signalling or in secure packet contains no SOR-CMCI rules). In step 1, the Tsor-cm timer is running in the UE (100). In step 2, the VPLMN or HPLMN AMF sends SoR-CMCI, without any SoR-CMCI rule either—in plain text or, —in a secured packet, and the USIM provides the ME with the SOR-CMCI in the USAT REFRESH with command qualifier of type “Steering of Roaming”.

In step 3, the UE (100) may perform procedure such as the tsor-cm timers are stopped and a wait is initiated for NAS signalling connection release to IDLE state or 5GMM-CONNECTED mode with RRC inactive indication i.e. RRC INACTIVE state in response to determining updated SOR CMCI rules to deactivate (i.e., when the SOR-CMCI received by the UE over N1 NAS signalling contains no SOR-CMCI rules). In this situation, the UE may not initiate the deregistration procedure; i.e., the UE may not send any NAS message like deregistration message to the network. Instead, the UE may wait for the network to release the NAS signalling connection either to IDLE state or 5GMM-CONNECTED mode with RRC inactive indication; i.e., RRC INACTIVE state before performing PLMN selection to attempt selecting higher priority PLMN; i.e., the UE may wait until it moves to idle mode or 5GMM-CONNECTED mode with RRC inactive indication (see 3GPP TS 24.501) before attempting to obtain service on a higher priority PLMN (as specified in clause TS 23.122 clause 4.4.3.3) by acting as if timer T that controls periodic attempts has expired.

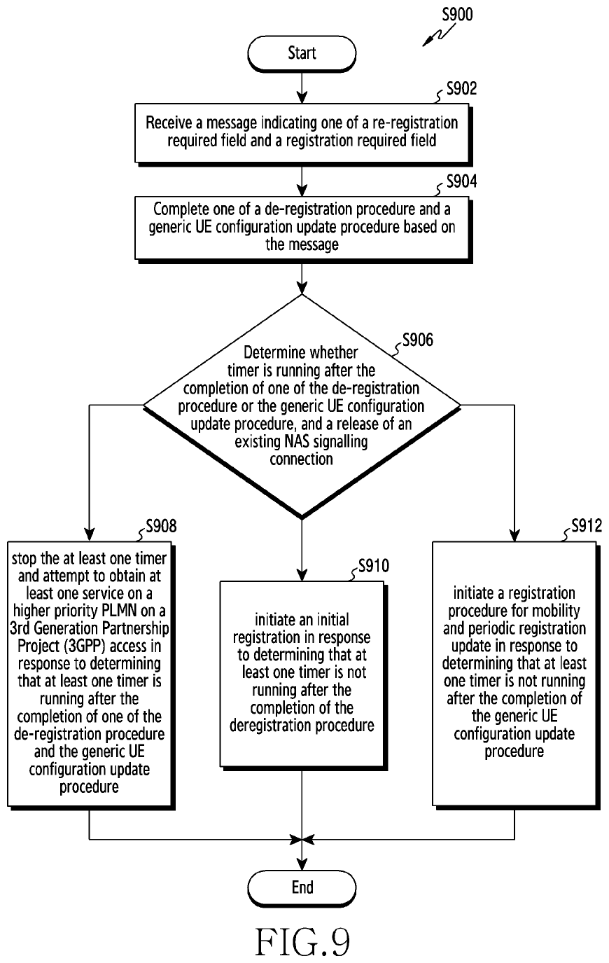

FIG. 9 illustrates flow chart (S900) of method for handling network initiated procedure(s) during Tsor-cm timer, according to the embodiments as disclosed herein. The operations (S902-S912) are handled by the PLMN selection procedure controller.

At S902, the method includes receiving the message indicating one of the re-registration required field and the registration required field. At S904, the method includes completing one of the de-registration procedure and the generic UE configuration update procedure based on the message. At S906, the method includes determining whether at least one timer is running after the completion of one of the de-registration procedure, the generic UE configuration update procedure, and a release of an existing Non-access stratum (NAS) signalling connection. In an embodiment, at S908, the method includes stopping the at least one timer and attempt to obtain at least one service on a higher priority PLMN on a 3^{rd} Generation Partnership Project (3GPP) access in response to determining that at least one timer is running after the completion of one of the de-registration procedure and the generic UE configuration update procedure. In another embodiment, at S910, the method includes initiating an initial registration in response to determining that at least one timer is not running after the completion of the de-registration procedure. In another embodiment, at S912, the method includes initiating a registration procedure for mobility and periodic registration update in response to determining that at least one timer is not running after the completion of the generic UE configuration update procedure.

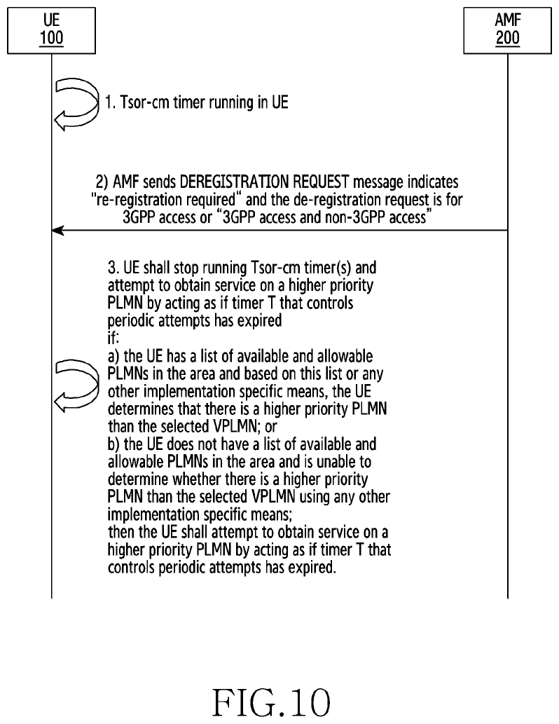

FIG. 10 illustrates a scenario, wherein the UE (100) triggers the higher priority PLMN search after receiving the deregistration message indicating “re-registration required” and the de-registration request is for 3GPP access or 3GPP access and non-3GPP access from the network. In step 1, the Tsor-cm timer is running in the UE (100). In step 2, the AMF (200) sends the DEREGISTRATION REQUEST message, where the message indicates “re-registration required” and the de-registration request is for 3GPP access or “3GPP access and non-3GPP access”. In step 3, after the UE (100) goes to the IDLE state (i.e. after the completion of the de-registration procedure), and optionally after the release of the existing NAS signalling connection, the UE (100) may stop running Tsor-cm timer(s) and attempt to obtain service on a higher priority PLMN, wherein the UE (100) considers that the timer T that controls periodic attempts has expired.

In other words, the UE (100) may stop running Tsor-cm timer(s) and attempt to obtain service on the higher priority PLMN by acting as if timer T that controls periodic attempts has expired if a) the UE (100) has a list of available and allowable PLMNs in the area and based on this list or any other implementation specific means, the UE (100) determines that there is a higher priority PLMN than the selected VPLMN; or b) the UE (100) does not have a list of available and allowable PLMNs in the area and is unable to determine whether there is a higher priority PLMN than the selected VPLMN using any other implementation specific means; then the UE (100) may attempt to obtain service on a higher priority PLMN by acting as if timer T that controls periodic attempts has expired.

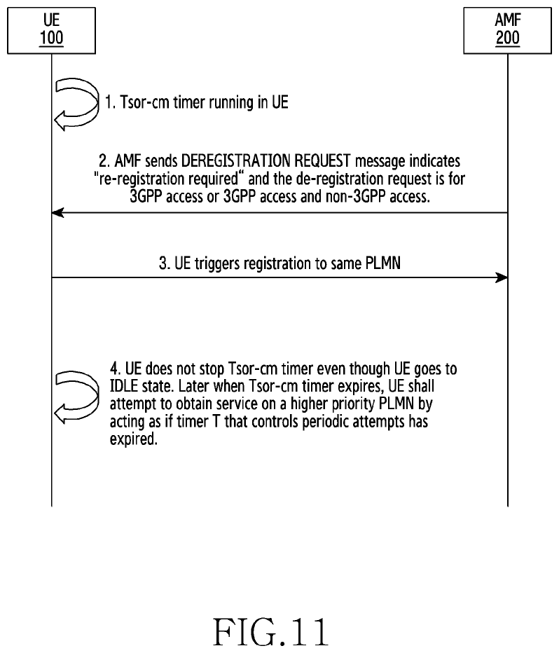

FIG. 11 illustrates a scenario, wherein the UE (100) triggers the registration request after receiving the deregistration message indicating “re-registration required” and the de-registration request is for 3GPP access or 3GPP access and non-3GPP access from the network. In step 1, the Tsor-cm timer is running in the UE (100). In step 2, the AMF (200) sends the DEREGISTRATION REQUEST message, wherein the message indicates “re-registration required” and the de-registration request is for 3GPP access or “3GPP access and non-3GPP access”. In step 3, after the UE (100) goes to the IDLE state i.e. after the completion of the de-registration procedure, and the release of the existing NAS signalling connection, the UE (100) does not stop Tsor-cm timer and the UE (100) triggers a registration to the same PLMN. In step 4, the Tsor-cm timer has expired and the UE (100) may attempt to obtain service on the higher priority PLMN, wherein the UE (100) considers that the timer T that controls periodic attempts has expired. In an embodiment herein, the UE (100) can set the value of the Tsor-cm timer after receiving a network initiated deregistration message, wherein the deregistration message indicates “re-registration required” and the de-registration request is for 3GPP access or 3GPP access and non-3GPP access. If the UE follows the procedure depicted in FIG. 11, after the UE (100) receives the network initiated deregistration procedure with registration required, the UE (100) may apply one of the following values of Tsor-cm timer:
a) Tsor-cm value may set to 0; i.e. the UE (100) may perform deregistration immediately after registration procedure is completed.
b) Tsor-cm timer may restart based on the services that the UE (100) is going to use or previous ongoing services.
c) Tsor-cm timer may be resumed from the elapsed value, before the UE moves to deregistered state.
d) Tsor-cm timer may be set to infinite.

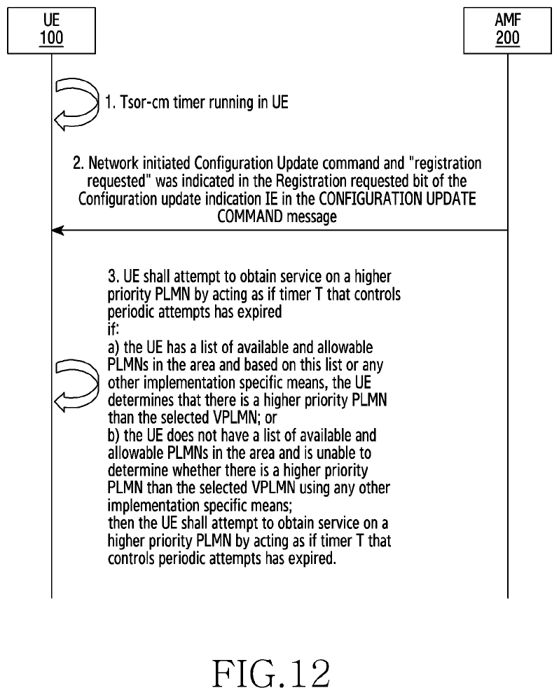

FIG. 12 illustrates a scenario, wherein the UE (100) triggers the higher priority PLMN search after receiving a network initiated Configuration Update command and “registration requested” was indicated in the Registration requested bit of the Configuration update indication IE in the CONFIGURATION UPDATE COMMAND message. In step 1, the Tsor-cm timer is running in the UE (100). In step 2, the network initiated Configuration Update command and “registration requested” was indicated in the Registration requested bit of the Configuration update indication IE in the CONFIGURATION UPDATE COMMAND message. In step 3, after releasing the NAS signalling connection, the UE (100) may stop the Tsor-CM timer(s) and attempt to obtain service on a higher priority PLMN by considering that the timer T that controls periodic attempts has expired.

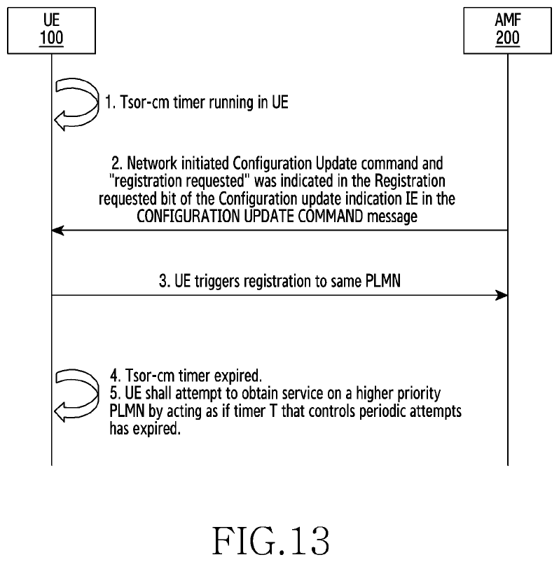

FIG. 13 illustrates a scenario, wherein the UE (100) triggers a registration request after receiving a network initiated Configuration Update command and “registration requested” was indicated in the Registration requested bit of the Configuration update indication IE in the CONFIGURATION UPDATE COMMAND message. In step 1, the Tsor-cm timer is running in the UE (100). In step 2, the network initiated Configuration Update command and “registration requested” was indicated in the Registration requested bit of the Configuration update indication IE in the CONFIGURATION UPDATE COMMAND (CUC) message. In step 3, the UE (100) triggers registration to the same PLMN. In step 4, the Tsor-cm timer has expired, and the UE (100) may attempt to obtain service on a higher priority PLMN by considering that the timer T that controls periodic attempts has expired.

In step 5, in yet another embodiment herein, after the UE (100) goes to IDLE state i.e. after the completion of the CUC procedure, and the release of the existing NAS signalling connection, the UE does not stop Tsor-cm timer and the UE triggers registration to the same PLMN later, when the Tsor-cm timer has expired. The UE may attempt to obtain service on a higher priority PLMN by considering that the timer T that controls periodic attempts has expired.

If UE follows the procedure depicted in FIG. 13, after the UE receives the Configuration Update Command with “registration requested” indicated in the Registration requested bit of the Configuration update indication IE, the UE may apply one of the following values of Tsor-cm timer:Tsor-cm value may set to 0; i.e. UE may perform deregistration immediately after registration procedure is completed.
a) Tsor-cm timer may restart based on the services that the UE is going to use or previous ongoing services.
b) Tsor-cm timer may be resumed from the elapsed value before the UE moves to deregistered state.
c) Tsor-cm timer may be set to infinite.

If the UE (100) has aborted the registration procedure, then the UE (100) may enter 5GMM-REGISTERED state and ATTEMPTION TO REGISTRATION substrate. 5U2 NOT UPDATED. So that if the UE (100) comes back to the same PLMN after PLMN selection, the UE (100) remembers that it needs to trigger registration procedure.

In another embodiment, the UE (100) can maintain a flag that it needs to trigger registration procedure. In another embodiment, the UE (100) performs higher priority PLMN selection means. The UE (100) selects higher priority PLMN if below conditions are satisfied:
a) the UE (100) has a list of available and allowable PLMNs in the area and based on this list or any other implementation specific means, the UE (100) determines that there is a higher priority PLMN than the selected VPLMN; or
b) the UE (100) does not have a list of available and allowable PLMNs in the area and is unable to determine whether there is a higher priority PLMN than the selected VPLMN using any other implementation specific means, then the UE (100) may attempt to obtain service on a higher priority PLMN by considering that the timer T that controls periodic attempts has expired.

The various actions, acts, blocks, steps, or the like in the flow charts (S700 and S900) may be performed in the order presented, in a different order or simultaneously. Further, in some embodiments, some of the actions, acts, blocks, steps, or the like may be omitted, added, modified, skipped, or the like without departing from the scope of the invention.

In one embodiment, a method includes determining that a first Steering of Roaming (SOR) security check failure occurs upon receiving a first SOR information at the UE, wherein the UE is configured with a pre-configured priority for the VPLMN; starting a timer with a value included in a steering of roaming connected mode control information (SOR-CMCI) in response to determination; determining whether the UE has entered a connectivity state and a second SOR information is received before the UE entering into the connectivity state; and

performing one of: ignoring the pre-configured priority for the VPLMN and considering the VPLMN as a lowest priority in response to determining that the UE has entered into the state and the second SOR information is not received before the UE entering into the state or the received second SOR information security check is not successful, and considering a priority of the VPLMN as the pre-configured priority by not considering the VPLMN as a lowest priority and stopping the timer associated with the “first SOR security check not successful” in response to determining that the UE receives the second SOR information and a second SOR security check is successful before the UE enters into the state.

In one embodiment, wherein the timer with the value is associated with the “SOR security check not successful” is included in the SOR-CMCI stored at the UE, wherein the timer comprises a Tsor-cm timer.

In one embodiment, wherein at least one of the first SOR information and the second SOR information are provided in a downlink Non-access stratum (DL NAS) transport message or registration accept message to the UE.

In one embodiment, wherein the connectivity state is at least one of IDLE state and a 5GMM-CONNECTED mode with a radio resource control (RRC) inactive indication state.

A User Equipment (UE), the UE includes a processor; a memory; and a PLMN selection procedure controller, coupled with the processor (630) and the memory, configured to: determine that a first Steering of Roaming (SOR) security check failure occurs upon receiving a first SOR information at the UE, wherein the UE is configured with a pre-configured priority for the VPLMN; start a timer with a value included in a steering of roaming connected mode control information (SOR-CMCI) in response determination; determine whether the UE has entered a connectivity state and a second SOR information is received before the UE entering into the connectivity state; and perform one of: ignore the pre-configured priority for the VPLMN and consider the VPLMN as a lowest priority in response to determine that the UE has entered into the connectivity state and the second SOR information is not received before the UE entering into the connectivity state or the received second SOR information security check is not successful; and consider a priority of the VPLMN as the pre-configured priority by not considering the VPLMN as a lowest priority and stop the timer associated with the “first SOR security check not successful” in response to determining that the UE receives the second SOR information and a second SOR security check is successful before the UE enters into the connectivity state.

In one embodiment, wherein the timer with the value is associated with the “SOR security check not successful” is included in the SOR-CMCI stored at the UE, wherein the timer comprises a Tsor-cm timer.

In one embodiment, wherein at least one of the first SOR information and the second SOR information are provided in a downlink Non-access stratum (DL NAS) transport message or a registration accept message to the UE e.

In one embodiment, wherein the connectivity state is at least one of IDLE state and 5GMM-CONNECTED mode with a radio resource control (RRC) inactive indication state.

In one embodiment, a method includes receiving, by a User Equipment (UE), a message indicating one of a re-registration required field and a registration required field; completing, by the UE, one of a de-registration procedure and a generic UE configuration update procedure based on the message; determining, by the UE, whether at least one timer is running after the completion of one of the de-registration procedure, the generic UE configuration update procedure, and a release of an existing Non-access stratum (NAS) signalling connection; and performing, by the UE, one of: stopping the at least one timer and attempt to obtain at least one service on a higher priority PLMN on a 3rd Generation Partnership Project (3GPP) access in response to determining that at least one timer is running after the completion of one of the de-registration procedure and the generic UE configuration update procedure, initiating an initial registration in response to determining that at least one timer is not running after the completion of the de-registration procedure, and initiating a registration procedure for mobility and periodic registration update in response to determining that at least one timer is not running after the completion of the generic UE configuration update procedure.

In one embodiment, wherein the message comprises at least one of a configuration update command message and a deregistration request message, wherein the deregistration request message indicates the re-registration required field, and wherein the configuration update command message indicates the registration required field.

In one embodiment, wherein the configuration update command message indicates the registration requested field in a registration requested bit of a configuration update indication information element (IE), and wherein the configuration update command message comprises at least one of an allowed Network Slice Selection Assistance Information (NSSAI), a configured NSSAI and a network slicing subscription change indication or contains no other parameters.

In one embodiment, wherein the initial registration or the registration procedure for mobility and periodic registration update is initiated over at least one of a 3GPP access and a non-3GPP access.

A User Equipment (UE), the UE includes a processor; a memory; and a PLMN selection procedure controller, coupled with the processor and the memory, configured to: receive a message indicating one of a re-registration required field and a registration required field; complete one of a de-registration procedure and a generic UE configuration update procedure based on the message; determine whether at least one timer is running after the completion of one of the de-registration procedure or the generic UE configuration update procedure, and a release of an existing NAS signalling connection; and perform one of: stop the at least one timer and attempt to obtain at least one service on a higher priority PLMN on a 3rd Generation Partnership Project (3GPP) access in response to determining that at least one timer is running after the completion of one of the de-registration procedure and the generic UE configuration update procedure, and initiate an initial registration in response to determining that at least one timer is not running after the completion of the de-registration procedure, and initiate a registration procedure for mobility and periodic registration update in response to determining that at least one timer is not running after the completion of the generic UE configuration update procedure.

In one embodiment, wherein the message comprises at least one of a configuration update command message and a deregistration request message, wherein the deregistration request message indicates the re-registration required field, and wherein the configuration update command message indicates the registration required field.

In one embodiment, wherein the configuration update command message indicates the registration requested field in a registration requested bit of a configuration update indication information element (IE), and wherein the configuration update command message comprises at least one of an allowed Network Slice Selection Assistance Information (NSSAI), a configured NSSAI and a network slicing subscription change indication, or contains no other parameters.

In one embodiment, wherein the initial registration or the registration procedure for mobility and periodic registration update is initiated over at least one of a 3GPP access and a non-3GPP access.

The embodiments disclosed herein can be implemented through at least one software program running on at least one hardware device and performing network management functions to control the elements. The elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the scope of the embodiments as described herein.

The above flowcharts illustrate example methods that can be implemented in accordance with the principles of the disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

The methods according to the embodiments described in the claims or the detailed description of the disclosure may be implemented in hardware, software, or a combination of hardware and software.

When the electrical structures and methods are implemented in software, a computer-readable recording medium having one or more programs (software modules) recorded thereon may be provided. The one or more programs recorded on the computer-readable recording medium are configured to be executable by one or more processors in an electronic device. The one or more programs include instructions to execute the methods according to the embodiments described in the claims or the detailed description of the disclosure.

The programs (e.g., software modules or software) may be stored in random access memory (RAM), non-volatile memory including flash memory, read-only memory (ROM), electrically erasable programmable read-only memory (EEPROM), a magnetic disc storage device, compact disc-ROM (CD-ROM), a digital versatile disc (DVD), another type of optical storage device, or a magnetic cassette. Alternatively, the programs may be stored in a memory system including a combination of some or all of the above-mentioned memory devices. In addition, each memory device may be included by a plural number.

The programs may also be stored in an attachable storage device which is accessible through a communication network such as the Internet, an intranet, a local area network (LAN), a wireless LAN (WLAN), or a storage area network (SAN), or a combination thereof. The storage device may be connected through an external port to an apparatus according the embodiments of the disclosure. Another storage device on the communication network may also be connected to the apparatus performing the embodiments of the disclosure.

In the afore-described embodiments of the disclosure, elements included in the disclosure are expressed in a singular or plural form according to the embodiments. However, the singular or plural form is appropriately selected for convenience of explanation and the disclosure is not limited thereto. As such, an element expressed in a plural form may also be configured as a single element, and an element expressed in a singular form may also be configured as plural elements.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

While the disclosure has been shown and described with reference to various embodiments thereof, it will be understood by those skilled in the art that various changes in form and details may be made therein without departing from the spirit and scope of the disclosure as defined by the appended claims and their equivalents.

Although the present disclosure has been described with various embodiments, various changes and modifications may be suggested to one skilled in the art. It is intended that the present disclosure encompass such changes and modifications as fall within the scope of the appended claims.

What is claimed is:

1. A method of a user equipment (UE), the method comprising:
determining that a first steering of roaming (SOR) security check failure occurs upon receiving first SOR information, wherein the UE is configured with a pre-configured priority for a visited public land mobile network (VPLMN);
starting a timer based on a value included in SOR connected mode control information (SOR-CMCI) in response to determining that the first SOR security check failure occurs;
determining whether the UE has entered a connectivity state and second SOR information is received before the UE enters the connectivity state; and
performing one of:
ignoring the pre-configured priority for the VPLMN and determining the VPLMN as a lowest priority in response to determining that the UE has entered the connectivity state and the second SOR information is not received before the UE enters the connectivity state or the received second SOR information security check fails, or
determining a priority of the VPLMN as the pre-configured priority without the priority of the VPLMN; and stopping the timer when determining that the first SOR security check failure occurs in response to determining that the UE receives the second SOR information and a second SOR security check is successful before the UE enters the connectivity state.

2. The method of claim 1, wherein the timer with the value that is determined based on a determination that the first SOR security check failure occurs is included in SOR-connected mode control information (SOR-CMCI) stored at the UE and wherein the timer comprises a Tsor-cm timer.

3. The method of claim 1, wherein at least one of the first SOR information or the second SOR information is provided via a downlink non-access stratum (DL NAS) transport message or a registration accept message.

4. The method of claim 1, wherein the connectivity state comprises at least one of an IDLE mode or a fifth generation mobility management (5GMM)-CONNECTED mode with a radio resource control (RRC) inactive indication state.

5. A user equipment (UE), the UE comprising:
a processor;
memory; and
a public land mobile network (PLMN) selection procedure controller, coupled with the processor and the memory, configured to:
determine that a first steering of roaming (SOR) security check failure occurs upon receiving first SOR information, wherein the UE is configured with a pre-configured priority for a visited PLMN (VPLMN);
start a timer based on a value included in SOR connected mode control information (SOR-CMCI) in response to determining that the first SOR security check failure occurs;
determine whether the UE has entered a connectivity state and a second SOR information is received before the UE enters the connectivity state; and
perform one of:
ignoring the pre-configured priority for the VPLMN and determining the VPLMN as a lowest priority in response to determine that the UE has entered the connectivity state and the second SOR information is not received before the UE enters the connectivity state or the received second SOR information security check fails; or
determining a priority of the VPLMN as the pre-configured priority without the priority of the VPLMN and stopping the timer when determining that the first SOR security check failure occurs in response to determining that the UE receives the second SOR information and a second SOR security check is successful before the UE enters the connectivity state.

6. The UE of claim 5, wherein the timer with the value that is determined based on a determination that the first SOR security check failures occurs is included in SOR-connected mode control information (SOR-CMCI) stored at the UE, and wherein the timer comprises a Tsor-cm timer.

7. The UE of claim 5, wherein at least one of the first SOR information or the second SOR information is provided via a downlink non-access stratum (DL NAS) transport message or a registration accept message.

8. The UE of claim 5, wherein the connectivity state comprises at least one of an IDLE mode and a fifth generation mobility management (5GMM)-CONNECTED mode with a radio resource control (RRC) inactive indication state.
